(19) United States
(12) Patent Application Publication
(10) Pub. No.: US 2002/0040085 A1
(43) Pub. Date: Apr. 4, 2002

(54) Polymer matrix composites

(76) Inventors: Sridhar Venigalla, Macungie, PA (US); David V. Miller, Pittsburgh, PA (US); Jeffrey A. Kerchner, Fleetwood, PA (US)

Correspondence Address: Martha Ann Finnegan, Cabot Corporation, 157 Concord Road, Billerica, MA, 01821, US

(21) Appl. No.: 09/895,006

(22) Filed: Jun. 28, 2001

Related U.S. Application Data
(60) Provisional application No. 60/219,232, filed on Jul. 18, 2000.

(51) Int. Cl. C08K 3/18

(52) U.S. Cl. 524/432; 524/433

(57) ABSTRACT

A polymer matrix composite. The composite is made from a mixture of barium titanate-based particles dispersed in a polymeric resin. The mixture includes more than one barium titanate-based component, with each component having a different composition. The different barium titanate-based components are present in the mixture in specific proportions to provide the mixture with a relatively high, temperature-stable dielectric constant. Preferably, the mixture and resulting composite meets the temperature stability requirements to satisfy X7R capacitor specifications. The polymer matrix composite may be used in a number of applications, such as printed circuit boards which include embedded capacitors.

### RELATED APPLICATIONS

This application claims priority to U.S. Provisional Patent Application Serial No. 60/219,232, filed Jul. 18, 2000.

### FIELD OF THE INVENTION

The invention relates generally to composites and, more particularly, to composites that include mixtures of dielectric particles dispersed in a polymeric resin.

### BACKGROUND OF THE INVENTION

Ceramic dielectric particles may be dispersed in a polymeric resin to form a polymer matrix composite to improve certain electrical properties which may be important in electronic applications. For example, the dielectric constant of most polymeric resins is less than 5, while the dielectric constant of certain ceramic dielectrics may be greater than 100. Such polymer matrix composites, therefore, have an increased dielectric constant relative to the polymeric resin. The upper limit of the dielectric constant of the composite depends, in part, on the maximum volume fraction of particles that may be effectively dispersed in the resin to provide a coherent composite.

The capacitance of such polymer matrix composites, being directly proportional to the dielectric constant, is also elevated relative to that of the polymeric resin. However, in some cases, the capacitance of the composite may not be stable over ranges of temperature which may be disadvantageous in certain applications. For example, the capacitance of composites including pure barium titanate particles may vary as a function of temperature due to phase transformations of barium titanate. In particular, the tetragonal-cubic transformation that occurs near 125° C. typically causes an anomalous increase in dielectric constant, and thus capacitance, on the order of 300-500% the value of the dielectric constant at 25° C.

Such composites may be used, for example, as a substrate material for printed circuit boards. The enhanced electrical properties of the composite may impart such printed circuit boards with properties advantageous in a number of electronic applications including circuit boards that include embedded capacitors. In particular, it is desirable in many of these applications for the printed circuit board to have a high dielectric constant and a capacitance that varies by no more than +/−15% over the temperature range of −55° C. to 125° C. (X7R capacitor specifications).

Accordingly, a need exists for a composite having a high, temperature-stable dielectric constant.

### SUMMARY OF THE INVENTION

The invention provides a polymer matrix composite including a mixture of barium titanate-based particles dispersed in a polymeric resin. The mixture includes more than one barium titanate-based component, with each component having a different composition. The different barium titanate-based components are present in the mixture in proportions that provide the mixture with a relatively high, temperature-stable dielectric constant. Preferably, the mixture and resulting composite meets the temperature stability requirements to satisfy X7R capacitor specifications. The polymer matrix composite may be used in a number of applications, such as printed circuit boards which include embedded capacitors.

In one aspect, the invention provides a composite including a polymeric material and a particulate mixture dispersed in the polymeric material. The mixture includes more than one barium titanate-based component.

In another aspect, the invention provides a method of manufacturing a composite including providing a particulate mixture comprising more than one barium titanate-based component and dispersing the mixture in a polymeric material.

Other aspects, features, and advantages will become apparent from the following detailed description when considered in conjunction with the claims.

### DETAILED DESCRIPTION

The invention includes a composite of a mixture of barium titanate-based particles dispersed in a polymeric resin. Multiple barium titanate-based particulate components, such as pure barium titanate and/or solid solutions of barium titanate are included in the mixture. The different components are proportionately mixed, as described further below, to provide the resulting composite with the desired electrical properties which may include a high, temperature-stable dielectric constant. The polymer matrix may be selected as required by the application and, for example, may be an epoxy or thermosetting resin. The composite may be used, for example, as a printed circuit board.

The barium titanate-based particulate components may be pure barium titanate, solid solutions thereof, or other oxides based on barium and titanate having the general structure ABO₃, where A represents one or more divalent metals such as barium, calcium, lead, strontium, magnesium and zinc and B represents one or more tetravalent metals such as titanium, tin, zirconium, and hafnium. One type of barium titanate-based component has the structure Ba₍₁₋ₓ₎AₓTi_{(1-y)}B_{y}O₃, where x and y can be in the range of 0 to 1, where A represents one or more divalent metals other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate, and the like. In still other cases, where x or y is 1.0, barium or titanium may be completely replaced by the alternative metal of appropriate valence to provide a compound such as lead titanate or barium zirconate. In other cases, the component may be a compound may have multiple partial substitutions of barium or titanium. An example of a component that may include multiple partial substitutions is represented by the structural formula Ba_{(1-x-x′)}CaₓSr_{x′}Ti_{(1-y-y′)}Zr_{y}Hf_{y′}O₃ where x, x′, y, and y′ are equal to or greater than 0. For some components having the structure Ba_{(1-x-x′)}CaₓSr_{x′}Ti_{(1-y-y′)}Zr_{y}Hf_{y′}O₃, x is in the range of 0 to about 0.1, x′ is in the range of 0 to about 0.5, y is in the range of 0 to about 0.5, and y′ is in the range of 0 to about 0.1. In many cases, the barium titanate-based components will have a perovskite crystal structure, though in other cases they may not.

The mixture includes at least two barium titanate-based components which have different compositions. The mixture may include any number of components greater than one such as two, three, four, five, or even more components. In some cases, the mixture may include pure barium titanate as one component and one or more barium titanate solid solution component. For example, the mixture may include between greater than 0 and about 90 weight percent pure barium titanate and, in some cases, between about 25 and about 75 weight percent pure barium titanate. In other cases, the mixture may not include a pure barium titanate component but only barium titanate solid solution components. In some embodiments, the mixture may include components that have the same structural formula but have different elemental ratios. For example, the mixture may include a first component having the general formula BaTi_{(1-y)}Zr_{y}O₃, and a second component having the same general formula BaTi_{(1-y′)}Zr_{y′}O₃, where y has a different value than y′. In one embodiment, all of the components have the same structural formula Ba_{(1-x-x′)}CaₓSr_{x′}Ti_{(1-y-y′)}Zr_{y}Hf_{y′}O₃, where x, x′, y, and y′ are equal to or greater than 0.

Certain properties of the mixture depend upon properties of the individual components and their relative amounts in the mixture. These properties of the mixture, therefore, may be tailored by mixing particular components at specific ratios. By mixing several components, it may be possible to utilize the advantageous properties of more than one component. Thus, it is possible to produce a mixture which has properties that are better than the properties achievable with any single component. For example, a first component may have a high dielectric constant over a first temperature range, while a second component may have a high dielectric constant over a second temperature range. The resulting mixture of the first and the second component, thus, may have a high dielectric constant over both the first and the second temperature range.

In some embodiments, the components are selected and mixed in relative amounts such that the mixture, in powder form, has a dielectric constant at room temperature between about 200 and about 2000, and more preferably between about 500 and about 1000. In some embodiments, the mixture has a dielectric constant, and thus capacitance, that varies by no more than +/−15% over the temperature range of −55° C. and 125° C.

In one set of embodiments, the mixture includes multiple components which have different zirconium concentrations. The zirconium concentration in the barium titanate solid solution component has been found to strongly affect the temperature of the tetragonal-cubic phase transformation which causes an increase in the dielectric constant. As described above, the tetragonal-cubic transformation of pure barium titanate occurs near 125° C. and causes an anomalous peak in the dielectric constant on the order of 300-500% of its value at 25° C. Increasing the zirconium concentration in a barium titanate solid solution shifts the tetragonal-cubic phase transformation and, thus, the dielectric peak, to lower temperatures. Mixtures having multiple barium titanate solid solution components with different zirconium concentrations, thus, have multiple respective dielectric peaks at different temperatures. Components having different zirconium concentrations may be mixed in relative proportions so that the peaks overlap which results in a high, relatively stable dielectric constant for the mixture over a broad temperature range. In some embodiments, the mixture includes four components having a varying zirconium concentration, each between about 20% and about 40% by weight of the mixture and having the general formula Ba_{(1-x-x′)}CaₓSr_{x′}Ti_{(1-y-y′)}Zr_{y}Hf_{y′}O₃ where all four components have x, x′, and y′ values equal to or greater than 0, the first component has a y value of 0, the second component has a y value between 0 and about 0.15, the third component has a y value between about 0.15 and about 0.25, and the fourth component has a y value between about 0.25 and about 0.50.

The barium titanate-based components may have a variety of different particle characteristics. The barium titanate-based particles may have an average primary particle size of less than about 10 microns; in some cases, the average primary particle size is less than about 1.0 micron; in some cases, the average primary particle size may be less than about 0.5 micron; most preferably, the average primary particle size is about 0.1 micron or less. In some embodiments, the barium titanate-based primary particles will agglomerate and/or aggregate to form aggregates and/or agglomerates of aggregates. At times, it may be preferable to use barium titanate-based particles that are not strongly agglomerated and/or aggregated such that the particles may be relatively easily dispersed, for example, by high shear mixing.

The barium titanate-based particles may also have a variety of shapes which may depend, in part, upon the process used to produce the particles. For example, milled barium titanate-based particles generally have an irregular, non-equiaxed shape. In other cases, the barium titanate-based particles may be equiaxed and/or substantially spherical. In some embodiments, substantially spherically-shaped barium titanate-based particles may pack better and, thus, can increase the weight percentage of particles that can be effectively dispersed in the polymer matrix.

In some embodiments, the barium titanate-based particle components may be coated with dopant metal compounds, such as oxides or hydroxides, to enhance certain electrical or mechanical properties. The dopant metals may include lithium, magnesium, calcium, strontium, scandium, zirconium, hafnium, vanadium, niobium, tantalum, manganese, cobalt, nickel, zinc, boron, silicon, antimony, tin, yttrium, lanthanum, lead, bismuth or a Lanthanide element. Suitable coated particles have been described, for example, in commonly-owned, co-pending U.S. patent application Ser. No. 08/923,680, filed Sep. 4, 1997, which is incorporated herein by reference in its entirety.

The barium titanate-based particle components may be produced according to any technique known in the art including hydrothermal processes, solid-state reaction processes, sol-gel processes, as well as precipitation and subsequent calcination processes, such as oxalate-based processes. In some embodiments, it may be preferable to produce the barium titanate-based particles using a hydrothermal process. Hydrothermal processes generally involve mixing a barium source with a titanium source in an aqueous environment to form a hydrothermal reaction mixture which is maintained at an elevated temperature to promote the formation of barium titanate particles. When forming barium titanate solid solution particles hydrothermally, sources including the appropriate divalent or tetravalent metal may also be added to the hydrothermal reaction mixture. Certain hydrothermal processes may be used to produce substantially spherical barium titanate-based particles having a particle size of less than 1.0 micron and a uniform particle size distribution. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

The different particulate components, generally, are prepared in separate processes and are subsequently mixed together to form a homogeneous mixture. The different particulate components may be added to the mixture in one of several states. For example, the particulate components may be added to the mixture as a dry powder, an aqueous slurry, or a non-aqueous slurry. Any suitable mixing technique known in the art for mixing the particular components may be used to produce the homogeneous mixture. Such techniques include mechanical blending, stirring, milling, and the like. Accordingly, the state of the resulting mixture (e.g., dry powder, aqueous slurry, or non-aqueous slurry) will depend upon the state of the components. In some embodiments, the state of the resulting mixture may be changed as desired for further processing. For example, a mixture that is a dry powder may be dispersed to form a slurry, or a mixture that is a slurry may be dried to form a dry powder.

The mixture of barium titanate-based particle components are dispersed in a polymer material, as described further below. The polymeric material may be any type known in the art including thermoplastic resins, thermoplastic elastomers, thermosetting resins, and mixtures thereof. Suitable polymers include but are not limited to resins of polycarbonate, polyethylene, polyethylene terephthalate, polypropylene, polystyrene, polyphenylene oxide, polyesters, polyamides, polyimides, and epoxies. In some embodiments, an epoxy is the preferred polymeric material. The particular type of polymeric material is determined, in part, by requirements of the application. For example, the polymeric material in composites used in printed circuit board applications are selected for electrical properties (i.e., dielectric constant, dissipation factor, and the like), compatibility with temperatures in further processing steps and compatibility with temperatures during use.

To form the composite, the mixture is added to the polymeric resin when the resin is in a fluid state. Resins in the fluid state include molten resins or pre-cursors of resins, such as epoxies prior to curing. As discussed above, the mixture may be a dry powder or an aqueous slurry. When added as an aqueous slurry or non-aqueous slurry, the liquid phase may aid in the dispersion of the particles and will typically evaporate in later processing steps. Conventional dispersing techniques such as mechanical mixing, or ball milling may be used to disperse the mixture in the resin. Generally, it is preferable to disperse the mixture uniformly throughout the resin. To aid dispersion, the particles may be coated with a dispersing agent. In some cases, the particles may be coated with a coupling agent, such as a silage-based coupling agent, to promote linkage between the polymeric matrix and the particles.

The resulting fluid resin-particulate mixture is further processed depending, in part, upon the particular structure and desired application of the composite. In some cases, the fluid resin-particulate mixture may be cast as a thin film and cured (e.g., when the resin is an epoxy) or cooled (e.g., when the fluid resin is a molten polymeric material) to form the polymer-matrix composite.

The weight percentage of the mixture in the composite may vary based on the application. For example, the composite may contain between about 60 percent and about 95 percent of the mixture based on the total weight of the composite. In some embodiments, the composite contains between about 80 percent and about 95 percent of the mixture based on the total weight of the composite The exact weight percent of the particulate mixture in the composite may be selected based on the requirements (e.g. dielectric constant, temperature stability) of the particular application.

The dielectric constant of the composite is generally in the range of between about 10 and about 100, and more preferably in the range of between about 50 and about 100. The dielectric constant generally increases with increasing weight percentage of the mixture. The dielectric constant and, thus, capacitance may be stable over a range of temperatures. In some embodiments, the dielectric constant and capacitance of the composite varies by no more than +/−15% within the temperature range of −55° C. and 125° C. In these embodiments, the composite meets the temperature stability requirements for X7R capacitor specifications. The composites of the invention may have a higher dielectric constant and capacitance than composites having an equal weight percentage of a single barium titanate-based component.

The composite may be further processed as known in the art for use in a number of electronic applications. The composite is particularly well-suited for use as a substrate material in printed circuit board applications. In one preferred application, the composite is used as a circuit board that includes embedded capacitors which are integral with the circuit board. In these applications, the composite forms the dielectric layer of the embedded capacitor which is disposed between two metallic layers. Embedded capacitors may replace conventionally board-mounted discrete capacitors in certain applications and, thus, save valuable circuit board space, help miniaturize the electronic packaging, as well as eliminate solder joints and the costs involved in mounting discrete capacitors. In addition, embedded capacitors may provide superior performance in high frequency applications as compared to conventionally board-mounted discrete capacitors.

Although particular embodiments of the invention have been described in detail for purposes of illustration, various changes and modifications may be made without departing from the scope and spirit of the invention. Accordingly, the invention is not to be limited except as by the appended claims.

What is claimed is:

1. A composite comprising:
a polymeric material; and
a particulate mixture dispersed in the polymeric material, the mixture including more than one barium titanate-based component.

2. The composite of claim 1, wherein each barium titanate-based component has the structural formula Ba_{(1-x-x′)}CaₓSr_{x′}Ti_{(1-y-y′)}Zr_{y}Hf_{y′}O₃ and x, x′, y, and y′ are equal to or greater than 0.

3. The composite of claim 1, wherein one of the barium titanate-based components comprises pure barium titanate.

4. The composite of claim 1, wherein at least one of the barium titanate-based components comprises a barium titanate solid solution.

5. The composite of claim 1, wherein each barium titanate-based component of the mixture has a different zirconium concentration.

6. The composite of claim 1, wherein the mixture comprises four components each having the structural formula Ba_{(1-x-x′)}CaₓSr_{x′}Ti_{(1-y-y′)}Zr_{y}Hf_{y′}O₃, all four components having x, x′, and y′ values equal to or greater than 0, the first component having a y value of 0, the second component having a y value between 0 and about 0.15, the third component having a y value between about 0.15 and about 0.25, and the fourth component having a y value between about 0.25 and about 0.50.

7. The composite of claim 1, wherein the mixture includes at least three components.

8. The composite of claim 1, wherein the composite has a dielectric constant of between about 10 and about 100.

9. The composite of claim 8, wherein the composite has a dielectric constant of between about 50 and about 100.

10. The composite of claim 1, wherein the composite has a capacitance that varies by less than +/−15 percent over the temperature range of −55° C. to 125° C.

11. The composite of claim 1, wherein each barium titanate-based component has an average particle size of less than about 0.5 micron.

12. The composite of claim 1, wherein each barium titanate-based component has a substantially spherical particle shape.

13. The composite of claim 1, wherein the composite comprises between about 60 and about 95 weight percent of the mixture based on the total weight of the composite.

14. The composite of claim 1, wherein the polymeric material comprises a resin selected from the group consisting of polycarbonate, polyethylene, polyethylene terephthalate, polypropylene, polystyrene, polyphenylene oxide, polyesters, polyamides, polyimides, and epoxies.

15. The composite of claim 14, wherein the polymeric material comprises an epoxy.

16. The composite of claim 1, wherein the composite is a substrate material for a printed circuit board.

17. The composite of claim 16, wherein the printed circuit board includes embedded capacitors, the composite comprising the dielectric of the embedded capacitors.

18. A method of manufacturing a composite comprising:
providing a particulate mixture comprising more than one barium titanate-based component; and
dispersing the particulate mixture in a polymeric material.

19. The method of claim 18, wherein the polymetric material is in a fluid state, and further comprising solidifying the polymeric material with the dispersed particulate mixture to form the composite.

20. The method of claim 19, wherein solidifying the polymeric material comprises curing the polymeric material.

21. The method of claim 19, further comprising processing the composite to form a printed circuit board.

22. The method of claim 19, further comprising casting the polymeric material in a fluid state as a thin film prior to solidifying.

23. The method of claim 19, wherein the composite has a dielectric constant of between about 10 and about 100.

24. The method of claim 23, wherein the composite has a dielectric constant of between about 50 and about 100.

25. The composite of claim 19, wherein the composite has a capacitance that varies by less than +/−15 percent over the temperature range of −55° C. to 125° C.

26. The method of claim 18, further comprising hydrothermally producing each barium titanate-based component.

27. The method of claim 18, wherein each barium titanate-based component has the structural formula Ba_{(1-x-x′)}CaₓSr_{x′}Ti_{(1-y-y′)}Zr_{y}Hf_{y′}O₃ and x, x′, y, and y′ are equal to or greater than 0.

28. The method of claim 18, wherein each barium titanate-based component has a different zirconium concentration.

29. The method of claim 18, wherein the mixture comprises four components each having the structural formula Ba_{(1-x-x′)}CaₓSr_{x′}Ti_{(1-y-y′)}Zr_{y}Hf_{y′}O₃, all four components having x, x′, and y′ values equal to or greater than 0, the first component has a y value of 0, the second component having a y value between 0 and about 0.15, the third component having a y value between about 0.15 and about 0.25, and the fourth component having a y value between about 0.25 and about 0.50.

30. The method of claim 18, wherein the polymeric material comprises a resin selected from the group consisting of polycarbonate, polyethylene, polyethylene terephthalate, polypropylene, polystyrene, polyphenylene oxide, polyesters, polyamides, polyimides, and epoxies.

31. The method of claim 30, wherein the polymeric material comprises an epoxy.
